(19) United States
(12) Patent Application Publication
(10) Pub. No.: US 2009/0049709 A1
(43) Pub. Date: Feb. 26, 2009

(54) Dryer and Dry Method for the Same

(76) Inventor: Young Jin Doh, Gyeongsangnam-do (KR)

Correspondence Address: MCKENNA LONG & ALDRIDGE LLP, 1900 K STREET, NW, WASHINGTON, DC, 20006, US

(21) Appl. No.: 12/224,665

(22) PCT Filed: Mar. 9, 2007
(86) PCT No.: PCT/KR2007/001185

§ 371 Date: Sep. 3, 2008

(30) Foreign Application Priority Data
Mar. 9, 2006 (KR) 10-2006-0022301

(51) Int. Cl. F26B 21/06; F26B 11/02; G05B 15/00

(52) U.S. Cl. 34/524; 34/132; 700/275

(57) ABSTRACT

The object of the present invention is to provide a method for drying in a dryer which can reduce power consumption at a small load by improving a drying method of the dryer. The object of the present invention can be achieved by providing a dryer including a drum for holding a drying object, a heater for providing hot air to the drying object, a sensing unit for producing a measured value varied with an amount of the drying object in the dram, and a control unit for determining the amount of the drying object from the measured value produced with the sensing unit, and controlling an operation capacity of the heater according to a result of the determination. In the meantime, the method for controlling a dryer having a dram for holding a drying object, and a heater for providing hot air to the drying object, includes the steps of starting drying, producing a measured value including information on an amount of a drying object held in a dram with a sensing unit which produces the measured value varied with the drying object in the dram, determining the amount of the drying object in the dram with reference to the measured value produced with the sensing unit, and controlling a capacity of a heater according to the amount of the drying object determined thus.

### TECHNICAL FIELD

The present invention relates to dryers for drying objects, such as clothes, and more particularly, to a dryer in which control of a heater is varied with an amount of a drying object for reducing power consumption, and a method for controlling the same.

### BACKGROUND ART

In general, the dryer dries drying object by blowing hot air generated with a heater thereto. In the dryers, there are an exhaust type dryer and a condensing type dryer depending on methods for processing humid air formed in a process of drying the drying object.

The exhaust type dryer uses a method in which the humid air from a drum is discharged to an outside of the dryer, and the condensing type dryer condenses the humid air from the drum to remove moisture therefrom and returns the air having the moisture removed therefrom to the drum again, to recirculate the air.

A structural example of a condensing type dryer will be described in detail with reference to an attached drawing FIG. 1.

FIG. 1 illustrates a diagram of a structure of a related art condensing type dryer, wherein arrow II indicates a circulating air flow.

Referring to FIG. 1, the related art condensing type dryer has a system in which a drum 11 is rotatably mounted in a body 10 having a door 12 in a front for holding the drying object, and connected to a motor 17 with a belt 19 so as to be rotated by the motor 17.

Mounted in a lower portion of the body 1, there is a condenser 13 for condensing high temperature, and humid air circulating through the drum 11 to remove moisture from the air, to make the circulating air dry. The condenser 13 has a front portion and a rear portion connected to a circulating duct 14 which is connected to a front and a rear of the drum 11 for introducing air discharged from the drum 11 to the drum 11 again through the condenser 13.

Mounted on the circulating duct 14, there are a heater 30 for heating the air passed through the condenser 13, and a circulating fan 16 for forced circulation of the air through the circulating duct 14. The circulating fan 16 is connected to other side of a shaft of the motor 17 which drives the drum 11.

A oil heater is used as the heater 30, mostly.

In the meantime, in order to condense the air circulating through the circulating duct 14 with the condenser by heat exchange, supply of external cold air to the condenser 13 is required. For this, the condenser 13 has one side connected to an external air supply duct (not shown) connected to an outside of the body 1, and a side opposite to the side of the condenser 13 having the external air supply duct connected thereto having a cooling fan (not shown) and a cooling fan driving motor 21 mounted thereto for forcible drawing of the external air through the external air supply duct and discharging the external air into the body 1.

The cooling fan driving motor 21 is a variable speed motor, such as a brushless DC motor, and drives the cooling fan only, separate from the motor 17 which rotates the circulating fan 16 and the drum 11.

In the meantime, mounted under the condenser 13, there are a water pan (not shown) for collecting the condensed water formed and fallen during the condensing process, and a pump 23 for forced discharge of the condensed water collected at the water pan to an outside of the dryer, or pumping the condensed water to a condensed water holding tank (not shown) in the body 1.

An unexplained reference numeral 22 denotes a lint filter for filtering foreign matters, such as lint, from the air discharged to the circulating duct 14 through the front of the drum 11.

The operation of the dryer will be described.

When the user selects a drying mode and starts operation of the dryer after introducing a wet drying object in the drum 11, the circulating fan 16 and the drying drum 11 rotate as the motor 17 and the heater 30 are put into operation in a state the cooling fan driving motor 21 is not in operation.

According to this, air flows through the circulating duct 14, and is heated at the heater 30, and introduced into the drum 11.

In this instance, since the cooling fan is not in operation, the air flowing through the circulating duct 14 is, not involved in heat exchange at the condenser 13, but flows toward the heater 30.

Then, if a preset time is passed or the air circulating through the drum 11 and the circulating duct 14 has a temperature risen to a target temperature, the cooling fan starts operation following operation of the cooling fan driving motor 21, so that the external air is supplied to the condenser 13 through the external air supply duct, passes through, heat exchanges at the condenser 13, and is discharged to an outside of the body 1 through one side of the body 1, and the air, which becomes hot and humid in a process of drying the drying object in the drum 11, is condensed by heat exchange as the air passes through the condenser 13, so as to be in a dry state, heated at the heater 30 again, and introduced into the drum 11.

### DISCLOSURE OF INVENTION

### Technical Problem

However, a drying method of the related art dryer has the following problems.

That is, since the related art dryer operates heater fully regardless of an amount of the drying object introduced into the drum, there is waste of power consumption of the heater in a case the amount of the drying object is small.

An object of the present invention devised to solve the problem lies on providing a dryer and a method for controlling the same, in which a capacity of the heater is controlled according to an amount of a drying object held in the drum, for reducing power consumption.

### Technical Solution

To achieve these objects and other advantages and in accordance with the purpose of the invention, as embodied and broadly described herein, a dryer includes a drum for holding a drying object, a heater for providing hot air to the drying object, a sensing unit for producing a measured value varied with an amount of the drying object in the drum, and a control unit for determining the amount of the drying object from the measured value produced with the sensing unit, and controlling an operation capacity of the heater according to a result of the determination.

In the meantime, the method for controlling a dryer having a drum for holding a drying object, and a heater for providing hot air to the drying object, includes the steps of starting drying, producing a measured value including information on an amount of a drying object held in a drum with a sensing unit which produces the measured value varied with the drying object in the drum, determining the amount of the drying object in the drum with reference to the measured value produced with the sensing unit, and controlling a capacity of a heater according to the amount of the drying object determined thus.

In another aspect of the present invention, a method for controlling a dryer having a drum for holding a drying object, a heater for providing hot air to the drying object, and an electrode sensor mounted to the drum for producing a resistance value varied with an amount of the drying object in the drum, includes the steps of inputting a drying course to start drying, calculating the resistance value between electrodes of the electrode sensor after starting of the drying step, determining the amount of the drying object by comparing the resistance value calculated thus to a preset reference value, and controlling a capacity of the heater according to the amount of the drying object determined thus.

### Advantageous Effects

Refer to “Industrial Applicability”

### BRIEF DESCRIPTION OF THE DRAWINGS

FIG. 1 illustrates a longitudinal section of key parts showing a structural example of a condensing type laundry dryer.

FIG. 2 illustrates a longitudinal section of key parts showing a structure of a dryer in accordance with a preferred embodiment of the present invention.

FIG. 3 illustrates a system diagram of a main system of a dryer in accordance with a preferred embodiment of the present invention.

FIG. 4 illustrates a flow chart of the steps of a method for controlling a dryer in accordance with a preferred embodiment of the present invention.

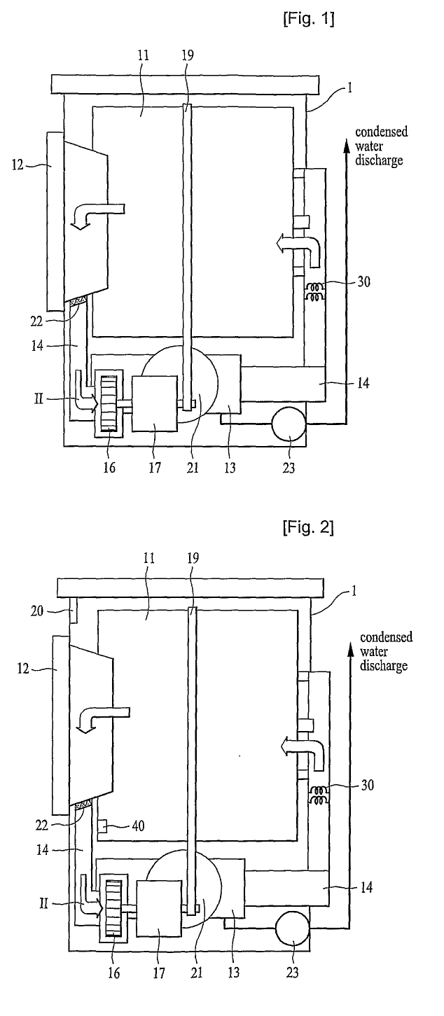

### BEST MODE FOR CARRYING OUT THE INVENTION

Reference will now be made in detail to the preferred embodiments of the present invention, examples of which are illustrated in the accompanying drawings 2 to 4.

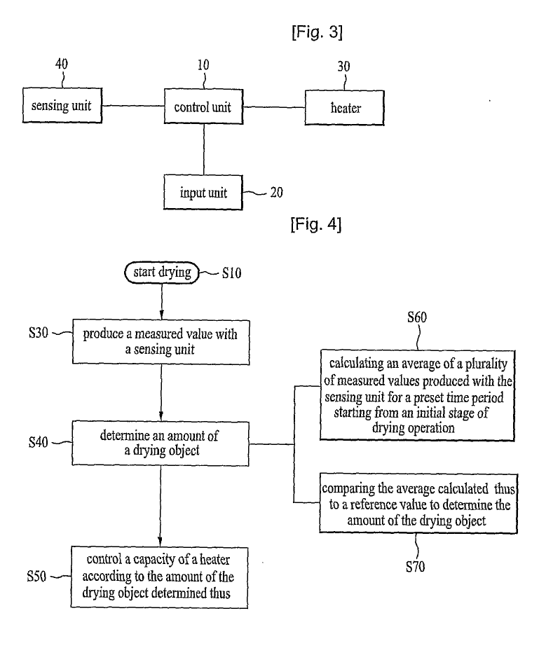

FIG. 2 illustrates a longitudinal section of key parts showing a structure of a dryer in accordance with a preferred embodiment of the present invention, FIG. 3 illustrates a system diagram of a main system of a dryer in accordance with a preferred embodiment of the present invention, and FIG. 4 illustrates a flow chart of the steps of a method for controlling a dryer in accordance with a preferred embodiment of the present invention.

Referring to FIGS. 2 and 3, the dryer includes a drum 11 for holding a drying object, a heater 30 for providing hot air to the drying object held in the drum 11, a sensing unit 40 for calculating a measured value varied with an amount of the drying object held in the drum 11, and a control unit 10 for determining the amount of the drying object from the measured value produced by the sensing unit 40, and controlling a operation capacity of the heater 300 according to a result of the determination.

The control unit 10 serves to control a drying performance of the dryer, and is mounted in the body 1. The control unit 10 receives a drying performance order from an input unit 20 such as a controller (not shown) and is provided with the measured value produced by the sensing unit 40, for controlling the operation capacity of the heater 30 according to the measured value.

The input unit 20 is mounted to an outside of the dryer, for applying the drying performance function to the control unit 10 according to selection of user. To do this, the input unit 20 has a plurality of buttons, and a display unit for displaying various kinds of information of the dryer.

The heater 30 serves to heat the air in the circulating duct 14 for producing hot air required for drying the drying object in the drum 11. The heater 30 is controlled by the controlling unit 10.

The sensing unit 40 and the control unit 10 will be described in detail.

At first, the sensing unit 40 will be described in detail. It is preferable that the sensing unit 40 is an electrode sensor with two electrodes for being brought into contact with the drying object in the drum 11. Then, as a wet drying object is brought into contact with the two electrodes, a current can flow to the electrode sensor, and an intensity of the current flowing to the electrode sensor can vary with the amount of the drying object which is brought into contact with the two electrodes. That is, the more the drying object which is brought into contact with the two electrodes, the stronger the intensity of the current to the electrode sensor.

Because, in general, the greater the moisture contained in the drying object which is brought into contact with the two electrodes, the conduction of the current becomes the better. Alikely, the more the drying object which is brought into contact with the two electrodes, the conduction of the current becomes the better owing to the more moisture which connects the two electrodes.

That is, because the intensity of the current to the electrode sensor can vary with the amount of the drying object which is brought into contact with the two electrodes, and the amount of the drying object which is brought into contact with the two electrodes can vary with the amount of the drying object held in the drum 11, the electrode sensor can produce the measured value varied with the amount of the drying object held in the drum 11, i.e., the current value.

Therefore, the measured value produced by the electrode sensor becomes to include information on the amount of the drying object held in the drum 11. For an example, if the current to the electrode sensor is great, it implies that the amount of the drying object in the drum 11 is great, and if the current to the electrode sensor is small, it implies that the amount of the drying object in the drum 11 is small.

In the meantime, the electrode sensor may be designed to produce a resistance value. That is, because the current value to the electrode sensor and the resistance value is inversely proportional, the resistance value the electrode sensor produces also includes information on the amount of the drying object in the drum 11. In this case, if the resistance value produced by the electrode sensor is small, it implies that the amount of the drying object in the drum 11 is great, and if the resistance value produced by the electrode sensor is great, it implies that the amount of the drying object in the drum 11 is small.

In the embodiment, though a case is described in which the electrode sensor is used as an example of the sensing unit 40, the sensing unit 40 is not limited to the electrode sensor. That is, the sensing unit 40 may be any sensor that can produce a measured value varied with the amount of the drying object in the drum 11.

Next, the control unit 10 will be described in detail.

The control unit 10 compares the measured value produced by the sensing unit 40 to a reference value, to determine the amount of the drying object. The reference value, set at the time of design of the product, is a reference for determining the amount of the drying object held in the drum 11, corresponding to the measured value produced by the sensing unit 40. For an example, if the sensing unit 40 is the electrode sensor, and the measured value produced by the electrode sensor is the resistance value, the reference value is a resistance value, and the measured value produced by the electrode sensor is the current value, the reference value is a current value.

Therefore, by Comparing the measured value produced by the sensing unit 40 to the reference value, and determining whether the measured value is greater than the reference value or not, the control unit 10 can determine whether the amount of the drying object is greater or not.

If the sensing unit 40 is the electrode sensor, it is preferable that the control unit 10 determines the amount of the drying object in the drum 11 from a plurality of measured values produced by the sensing unit 40 for a preset time period starting from initial drying operation.

It is because, as the drying object contains the greatest amount of moisture at the initial drying operation, the measured value produced by the electrode sensor at the initial drying operation is the most accurate information on the amount of the drying object held in the drum 11. Moreover, it is because, as some of the plurality of measured values produced by the sensing unit 40 can include wrong information on the amount of the drying object in the drum 11, the amount of the drying object can be determined more accurately by determining the amount of the drying object by comparing the plurality of measured values produced during the preset time period.

For an example, if the plurality of the measured values measured by the electrode sensor are resistance values, in a case at least one of the plurality of the resistance values is greater than the reference value, it is determined that the amount of the drying object in the drum 11 is small, and, in a case all of the resistance values are smaller than the reference value, it is determined that the amount of the drying object in the drum 11 is large.

More preferably, by calculating an average of the plurality of the measured values produced by the sensing unit 40 and comparing the average to the reference value, the control unit 10 can determine the amount of the drying object in the drum 11, more easily.

For an example, if the average, i.e., the resistance value is smaller than the reference value, the control unit 10 determines that the amount of the drying object is great, and if the average is greater than the reference value, the control unit 10 determines that the amount of the drying object is small.

As described, after determining the amount of the drying object in the drum 11, the control unit 10 controls the operation capacity of the heater 11 according to a result of the determination. That is, if the control unit 10 determines that the amount of the drying object is great, the control unit 10 increases the operation capacity of the heater 11, and if the control unit 10 determines that the amount of the drying object is small, the control unit 10 decreases the operation capacity of the heater 11.

Eventually, since the operation capacity of the heater 30 can be controlled according to the amount of the drying object in the drum 11, the dryer of the present invention can prevent the power consumption of the heater 30 from wasting, which is liable to take place when the amount of the drying object is small.

In the meantime, the reference value may be set to be one value, or a plurality of values different from one another. If the reference value is set to be one value, the control unit 10 can determine whether the amount of the drying object in the drum 11 is great or small, leading the control unit 10 to control the operation capacity of the heater 30 to be a operation capacity operated in a case the drying object is large, and to be a operation capacity operated in a case the drying object is small, only.

On the other hand if the reference value is set to be a plurality of values different from one another, the operation capacity of the heater 30 controlled by the control unit 10 can vary. That is, by comparing the plurality of values produced by the sensing unit 40, or an average thereof to the plurality of the reference values, the amount of the drying object can be determined more variably, and the operation capacity of the heater 30 can be controlled more variably, accordingly.

One example of the operation of the dryer of the present invention will be described in detail. That is, a case will be described in which the sensing unit 40 is the electrode sensor, the measured value produced by the electrode sensor is a resistance value, and one reference value is set.

At first, once drying operation is started following user's input of a drying operation time period a drying course, and the like through the input unit 20, the heater 30 is operated to provide hot air to the drying object in the drum 11.

In this instance, it is preferable that the heater 30 is operated in a full capacity for a preset time period at an initial stage, because it is required to elevate a temperature of an inside of the drum 11 regardless of the amount of the drying object in the drum 11 at the initial drying operation. There may be a plurality of the preset time periods in each of which the heater 30 is operated at the full capacity at the initial drying operation, which is a time period preset at the time of a product design, for user's option, or varying with drying courses.

Once the drying operation is started the two electrodes of the electrode sensor is brought into contact with the drying object, so that the electrode sensor process the resistance values for a preset time period starting from the initial stage of the drying operation.

In this instance, the plurality of resistance values produced by the electrode sensor are transmitted to the control unit 10, and the control unit 10 compares the plurality of resistance values to the reference value, to determine the amount of the drying object in the drum 11.

Preferably, the control unit 10 calculates an average of the plurality of resistance values produced for a preset time period by the electrode sensor, and compares the average to the reference value, to determine the amount of the drying object.

In this instance, if the control unit 10 determines that the amount of the drying object is large, the control unit increases the operation capacity of the heater 30. If it is a case when the heater 30 is operated at the full capacity at the initial stage of the drying operation, the control unit 10 does not change the operation capacity of the heater 30, but controls to operate the heater 30 at the full capacity continuously for the drying operation time period inputted by the user, or the drying operation time period preset according to the drying course.

If the control unit 10 determines that the drying object is small, the control unit 10 reduces the operation capacity of the heater 30. If it is a case when the heater 30 is operated at the full capacity at the initial stage of the drying operation, the control unit 10 reduces the capacity of the heater 30 to a capacity proper to the amount of the drying object after the preset time period in which the heater 30 is operated at the full capacity.

A method for controlling a dryer in accordance with a preferred embodiment of the present invention will be described. FIG. 4 illustrates a flow chart of the steps of a method for controlling a dryer in accordance with a preferred embodiment of the present invention.

Referring to FIG. 4, the method for controlling a dryer in accordance with a preferred embodiment of the present invention includes the steps of starting drying following user's input (S10), producing a measured value including information on an amount of a drying object held in a drum with a sensing unit 40 which produces the measured value varied with the drying object in the drum 11 (S30), determining the amount of the drying object in the drum 11 with reference to the measured value produced with the sensing unit 40 (S40), and controlling a capacity of a heater 30 according to the amount of the drying object determined thus (S50).

In this instance, the step for determining the amount of the drying object in the drum 11 (S40) may further include the steps of calculating an average of a plurality of measured values produced with the sensing unit 40 during a preset time period starting from an initial drying operation (S60), and comparing the average calculated thus to a reference value to determine the amount of the drying object (S70).

The step of comparing the average calculated thus to a reference value to determine the amount of the drying object (S70) includes the steps of, if the average and the reference value are resistance values, it is determined that the amount of the drying object is large if the average is larger than the reference value, and it is determined that the amount of the drying object is small if the average is smaller than the reference value.

Moreover, in the step of controlling a capacity of a heater 30 (S50) in a case the heater 30 is operated at a full capacity at the starting of the drying, the operation capacity of the heater 30 is maintained at the full capacity if it is determined that the amount of the drying object is large, and the operation capacity of the heater 30 is reduced to a capacity smaller than the full capacity if it is determined that the amount of the drying object is small.

In the meantime, in a case there are a plurality of reference values, in the step of comparing the average calculated thus to a reference value to determine the amount of the drying object (S70), the average calculated thus is compared to all the plurality of reference values, to determine the amount of the drying object. In this case, the step of controlling a capacity of a heater 30 (S50) may further include the steps of determining a load on the heater 30 according to the amount of the drying object determined thus, and controlling the capacity of the heater 300 according to the load on the heater 30.

As another embodiment, the step of determining the amount of the drying object in the drum 11 (S40) may be made with reference to each of the plurality of measured values produced with the sensing unit 40 within two minutes after starting of the drying step.

In this case, if an electrode sensor is used as the sensing unit 40, and the value produced with the sensing unit 40 is a resistance value, the step of determining the amount of the drying object (S40) may include the steps of determining that the amount of the drying object is large if all of the plurality of measured values produced with the electrode sensor 40 for 5 seconds after starting of the drying are smaller than the reference value, and determining that the amount of the drying object is small if otherwise, i.e., at least one of the plurality of measured values produced with the electrode sensor 40 for 5 seconds after starting of the drying is larger than the reference value.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

### INDUSTRIAL APPLICABILITY

As has been described the dryer and a method for controlling a dryer of the present invention have the following advantages.

First, the determining the amount of the drying object by using a measured value produced with the sensing unit and controlling a capacity of the heater according to the amount of the drying object permits to reduce power consumption wasted in a case the amount of the drying object is small.

Second the control of the capacity of the heater varying with the amount of the drying object permits to extend a lifetime of the heater.

1. A dryer comprising:
a drum for holding a drying object;
a heater for providing hot air to the drying object;
a sensing unit for producing a measured value varied with an amount of the drying object in the drum; and
a control unit for determining the amount of the drying object from the measured value produced with the sensing unit, and controlling an operation capacity of the heater according to a result of the determination.

2. The dryer as claimed in claim 1, wherein the sensing unit is an electrode sensor having two electrodes for being brought into contact with the drying object in the drum.

3. The dryer as claimed in claim 2, wherein the control unit compares each of a plurality of measured values produced with the electrode sensor for a preset time period starting from an initial stage of a drying operation to a preset reference value, to determine the amount of the drying object in the drum.

4. The dryer as claimed in claim 3, wherein, if the plurality of the measured values measured by the electrode sensor are resistance values, in a case at least one of the plurality of the resistance values is larger than the reference value, if each of the plurality of resistance values is compared to the reference value, the control unit determines that the amount of the drying object in the drum is small, and in a case all of the resistance values are smaller than the reference value, the control unit determines that the amount of the drying object in the drum is large.

5. The dryer as claimed in claim 2, wherein the control unit calculates an average of the plurality of measured values produced with the electrode sensor during a preset time period starting from an initial drying operation, compares the average to the reference value, to determine the amount of the drying object in the drum.

6. The dryer as claimed in claim 5, wherein the plurality of measured values produced with the electrode sensor are resistance values, and the control unit determines that the amount of the drying object is large if the average is smaller than the reference value, and the amount of the drying object is small if the average is larger than the reference value.

7. The dryer as claimed in claim 1, wherein the sensing unit is mounted to one side of an inside of the drum.

8. The dryer as claimed in claim 1, further comprising an input unit for enabling selection of a drying operation mode.

9. A method for controlling a dryer having a drum for holding a drying object, and a heater for providing hot air to the drying object, the method comprising the steps of:
starting drying;
producing a measured value including information on an amount of a drying object held in a drum with a sensing unit which produces the measured value varied with the drying object in the drum;
determining the amount of the drying object in the drum with reference to the measured value produced with the sensing unit; and
controlling a capacity of a heater according to the amount of the drying object determined thus.

10. The method as claimed in claim 9, wherein the step for determining the amount of the drying object in the drum includes the steps of;
calculating an average of a plurality of measured values produced with the sensing unit during a preset time period starting from an initial drying operation, and
comparing the average calculated thus to a reference value to determine the amount of the drying object.

11. The method as claimed in claim 10, wherein the step of comparing the average calculated thus to a reference value to determine the amount of the drying object includes the steps of, if the average and the reference value are resistance values, determining that the amount of the drying object is large if the average is larger than the reference value, and
determining that the amount of the drying object is small if the average is smaller than the reference value.

12. The method as claimed in claim 11, wherein the step of controlling a capacity of a heater in a case the heater is operated at a full capacity at the starting of the drying includes the steps of;
maintaining the operation capacity of the heater at the full capacity if it is determined that the amount of the drying object is large, and
reducing the operation capacity of the heater to a capacity smaller than the full capacity if it is determined that the amount of the drying object is small.

13. A method for controlling a dryer having a drum for holding a drying object, a heater for providing hot air to the drying object, and an electrode sensor mounted to the drum for producing a resistance value varied with an amount of the drying object in the drum, the method comprising the steps of:
inputting a drying course to start drying;
calculating the resistance value between electrodes of the electrode sensor after starting of the drying step;
determining the amount of the drying object by comparing the resistance value calculated thus to a preset reference value; and
controlling a capacity of the heater according to the amount of the drying object determined thus.

14. The method as claimed in claim 13, wherein the step of determining the amount of the drying object includes the step of comparing each of a plurality of resistance values produced with the electrode senor within an initial stage preset time period after starting of the drying to the reference value to determine the amount of the drying object.

15. The method as claimed in claim 14, wherein it is determined that the amount of the drying object is large if all of the plurality of the resistance values are smaller than the reference value.

16. The method as claimed in claim 15, wherein the step of controlling a capacity of the heater includes the step of controlling to drive the heater at the full capacity for a preset time period in a case if it is determined that the amount of the drying object is large.

17. The method as claimed in claim 14, wherein it is determined that the amount of the drying object is small if at least one of the plurality of the resistance values is larger than the reference value.

18. The method as claimed in claim 17, wherein the step of controlling a capacity of the heater includes the step of controlling to drive the heater at a capacity smaller than the full capacity for a preset time period in a case if it is determined that the amount of the drying object is small.
